(19) United States
(12) Patent Application Publication
(10) Pub. No.: US 2005/0236906 A1
(43) Pub. Date: Oct. 27, 2005

(54) Electrical touch/proximity switch

(76) Inventors: Michael James Morgan, Oceanside, CA (US); Thomas Michael Rauscher, Oceanside, CA (US)

Correspondence Address: Rauscher Industries, 2257 Via Blanca, Oceanside, CA, 92054, US

(21) Appl. No.: 11/089,562

(22) Filed: Sep. 4, 2003

(51) Int. Cl. H02B 1/24

(52) U.S. Cl. 307/117

(57) ABSTRACT

An electronic switch or intensity controller for a light that is activated by a detectable change of capacitance and/or infrared radiation in the detection field comprising: a CPU connected to a power supply; at least one logic level triac connected electronically to the CPU; and an occupancy sensor connected electronically to the CPU having a means for detecting the presence of objects passing within the detection field.

### TECHNICAL FIELD

Field of endeavor is lighting, electrical, electronics and appliance controls.

### BACKGROUND OF THE INVENTION

Patents on switches and dimmers along with their reference numbers
1. U.S. Pat. No. 4,070,555
2. U.S. Pat. No. 4,242,552
3. U.S. Pat. No. 4,38,6254
4. U.S. Pat. No. 5,285,039
5. U.S. Pat. No. 5,826,710
6. U.S. Pat. No. 5,990,436

Touch/proximity of electrical, electronics and appliance control. No prior art.

Touch/proximity intensity control (dimming) of electrical, electronics and appliance. No prior art.

Occupancy sensing control of electrical, electronics and appliance.
1. U.S. Pat. No. 3,480,775
2. U.S. Pat. No. 3,631,434
3. U.S. Pat. No. 3,760,399
4. U.S. Pat. No. 3,958,118
5. U.S. Pat. No. 5,015,994
6. U.S. Pat. No. 5,107,120
7. U.S. Pat. No. 5,128,654

Problems with existing technology:
a. Wear out of mechanical potentiometer from intensity controller/controller functions;
b. Wearing out of all moving on/off/controlling of mechanical switching parts;
c. Difficulty in locating switch in dark;
d. Inability to turn on/off/switch and control functions with full hands;
e. Transfer of communicable germs while controlling said device;
f. Accumulation of grime on switch, walls and cover plate or apparatus;
g. Inability to control a separate apparatus remotely from any location in range of remote; and
h. Inability to maintain constant illumination of light without required intervention.

### SUMMARY OF THE INVENTION

The present provides an electronic switch or intensity controller for a light that is activated by a detectable change of capacitance and/or infrared radiation in the detection field comprising: a CPU connected to a power supply; at least one logic level triac connected electronically to the CPU; and an occupancy sensor connected electronically to the CPU having a means for detecting the presence of objects passing within the detection field. The means for detecting may be provided by ultrasonic detection, radio frequency detection, or inductance. The switch or controller maybe configured to operate in a one-way, two-way, three-way and/or four-way capacity and/or may be configured to allow multiple switches to be connected in a daisy-chained configuration to improve detection range. The capacitance change may be detected with or without touch. In the latter configuration the distance of detection is not less than about ⅛ inch and not more than about 3½ inches from the switch or controller. Alternatively, a change in capacitance may be detected by an audible sound that may be a natural or a manmade sound. The occupancy sensor may have the ability to count the number of objects or times an object passes within the detection field in a desired reference time period and may be provided with the ability of manual, touch or proximity override of illumination function.

The electronic switch or intensity controller according to claim 1 further comprising a radio frequency transceiver connected electronically to the CPU so that the switch or controller may be operated remotely. In addition, it may further comprise a light for illumination of the switch or controller or to additionally illuminate the area around the device.

### DESCRIPTION OF THE FIGURES

FIG. 1: Is a schematic diagram of the one electronic configuration of the present invention.

FIG. 2: a diagrammatic representation of the present invention detecting human presence by touch.

FIG. 3: a diagrammatic representation of the present invention detecting objects that generate heat via infrared radiation.

FIG. 4: is a schematic representation of one thermal sensing configuration of the present invention.

FIG. 5: is a diagrammatic representation of the input and output signals of the invention presented in FIG. 4.

### DETAILED DESCRIPTION

The present invention provides an electronic/electrical touch/proximity switch with optional remote controller, illumination and/or intensity controller function (dimmer) and/or occupancy sensing for power and functionality control on the worldwide power grid.

More particularly, the present provides an electronic switch or intensity controller for a light that is activated by a detectable change of capacitance and/or infrared radiation in the detection field comprising: a CPU connected to a power supply; at least one logic level triac connected electronically to the CPU; and an occupancy sensor connected electronically to the CPU having a means for detecting the presence of objects passing within the detection field.

An electronic/electrical touch/proximity switch designed for one-way, two-way, three-way or four-way switching configured touch/proximity wall switch with radio frequency (RF) control, display, intensity functions, occupancy sensing, and night light, or find light functions which operate lighting, electronic, electrical, electro-mechanical and appliances/applications on the world-wide power grid.

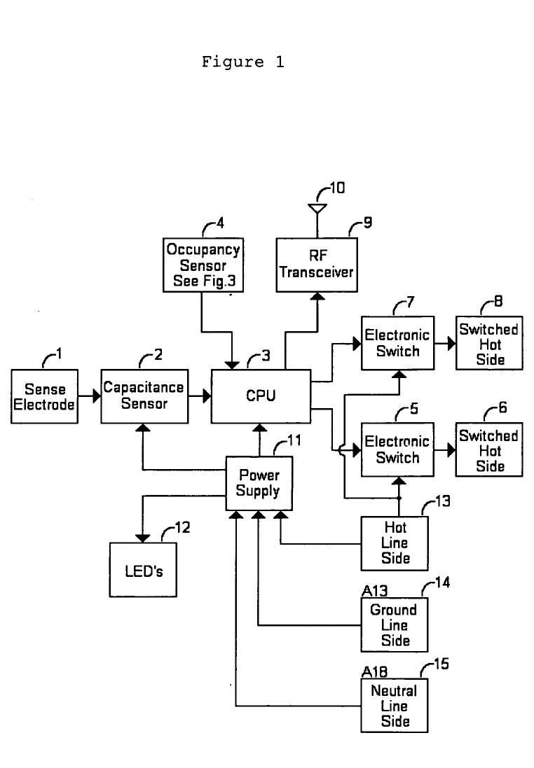

A lighting and electronic appliance control switch that is a self-contained unit/apparatus capable of detecting proximity, touch or occupancy and switching on/off/dimming lighting or appliances on a world-wide power grid, FIG. 1. This unit will project a sense field through almost any dielectric, like plastic, glass, stone, and ceramic. The unit can also turn small metal-bearing objects into intrinsic sensors, making them respond to proximity or touch. This unit is designed specifically for human interfaces, like lighting controls, control panels, appliances, or where a mechanical switch or button may be found and it may also be used for some material sensing and control applications, providing the presence duration of objects does not exceed the sense range.

Multiple switches of the lighting and electronic control switch of said self-contained unit/apparatus may be daisy-chained together to improve sense range when physically located in tight spaces.

The occupancy sensing function of the said self-contained unit/apparatus has the ability to count the number of entrances and exits of people and animals to determine illumination with the ability of intensity control and manual override.

The lighting and electronic control switch of said self-contained unit/apparatus has the ability to provide any color light in a “find” light or “night” light configuration.

The lighting and electronic control switch of said self-contained unit/apparatus has the ability to be operate in a one-way, two-way, three-way and/or four-way configuration on the world-wide power grid.

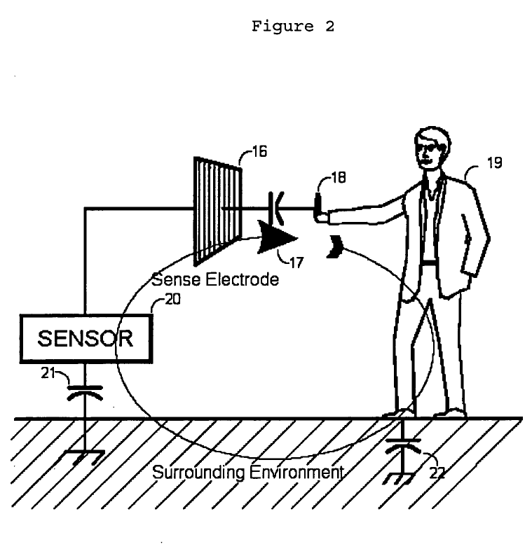

FIG. 1, shows the sense electrode (1) and capacitance sensor (2) that form the proximity or touch mechanism. See FIG. 2 for operation details. The occupancy sensor (4) has the ability to count the number of entrances and exits of people and animals to determine illumination with the ability of intensity control and manual override. A microcontroller (3) provides control and timing function. The microcontroller (3) directly drives the gate of a Logic Level Triac (5) and or (7). The triac (5) and or (7) is used to control the intensity of a device by switching the AC power (B9) on part-way through each half wave. By controlling where the triac (5) and or (7) is “fired” during the power-line cycle, the microcontroller (3) can control the average voltage across the filament of the device, and thus the intensity. The electronic switch (5) and (7) form a bi-directional switch that switches power to 120/240vac loads (6) and (8) from hot side-line (13). The power supply (11) provides regulated power to all circuits and incorporates an switching circuit for use from 85VAC to 270VAC from the AC mains. LED's (12) are optional “display/find/night” light. In addition, the RF transceiver (9) and antenna (10) are optional for the remote control or remote control of an external electric device on a same, non-switched power grid.

In FIG. 2, like all capacitance sensors, we rely on Kirchoff's Current Law (FIG. 1) to detect the change in capacitance of the electrode (16). This law, as applied to capacitive sensing, requires that the sensor's field current must complete a loop (17), returning back to its source in order for capacitance to be sensed. By implication of Kirchoff's Law, it requires that the signal ground and the target object must both be coupled together in some manner for a capacitive sensor to operate properly. There is no need to provide actual hardwired ground connections, because according to Kirchoff's Law, capacitive coupling to ground (22) is always sufficient. When battery powered, such as a motor vehicle, just the physical size of the PCB and the object into which the electronics is embedded, will generally be enough to couple a few picofarads back to local earth.

When detecting human presence (e.g. a fingertip [but not limited to], 18), hardwired grounding of the person is never required. The human body (19) naturally has several hundred picofarads of free space capacitance to the local environment (22), which provides more than two orders of magnitude (10 times) greater than that required for creating a return path.

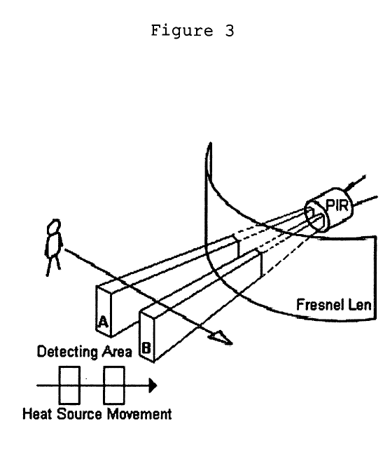

In FIG. 3, infrared radiation that exists in the electromagnetic spectrum at a wavelength that is longer than visible light and cannot be seen but it can be detected. Objects that generate heat also generate infrared radiation including animals and the human body whose radiation is strongest at a wavelength of 9.4 mm.

The PIR sensor has two sensing elements connected in a voltage-bucking configuration. This arrangement cancels signals caused by vibration, temperature changes and sunlight. A body (heat source) passing in front of the sensor will activate first one and then the other element as shown in FIG. 3 whereas other sources will affect both elements simultaneously and be cancelled. The radiation source must pass across the sensor in a horizontal direction, with the sensor also on a horizontal plane so that the elements are sequentially exposed to the IR source. This arrangement provides directional sensing

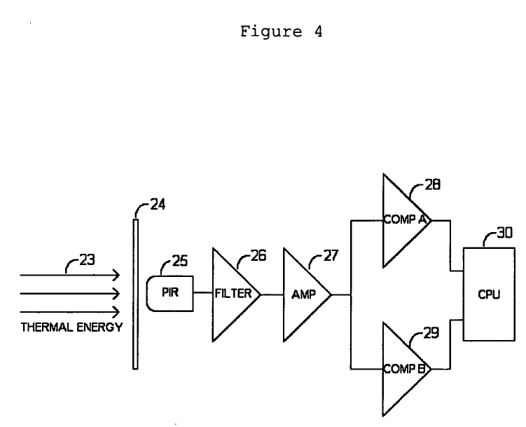

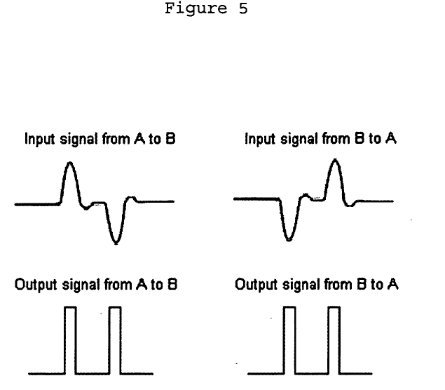

In FIG. 4, Fresnel lens (24) and PIR (25) form the front-end to detect thermal energy radiation (23). Filter (26) forms a bandpass function centered at 9.4 um to prevent noise from a false trigger. Amplifier (27) is typically bandwidth limited to about 10 Hz to reject high frequency noise and is followed by a window comparators (28) and (29) that responds to both the positive and negative transitions of the sensor output signal. Window comparator A (28) responses to the positive pulse, window comparator B (29) responses to the negative pulse. Direction A to B will generate the waveform in FIG. 5. The opposite direction, B to A, will generate the waveform in FIG. 5. CPU (30) processes the waveform generated by window comparator A (28) and B (29) based on time received to determine direction or count

The present invention is similar to the existing technology but is better because:
a. increased reliability (minimum ten times on intensity function and 2 times with on/off switching/control functions) of mechanical rocker/toggle switch/electrically variable potentiometer and intensity apparatuses;
b. no moving parts with on/off/intensity (dimming) control functions;
c. switch is illuminated;
d. switch operates within said distance;
e. eliminates up to 100 percent reduction in communicable germs;
f. eliminates up to 100 percent of accumulated grime from switch/control apparatus, cover plate and surrounding wall;
g. switch has RF remote functions for controlling or to be controlled remotely;
h. illuminates the required movement to maintain constant illumination;
i. has the ability to count the number of people or animals entering or leaving a room to determine occupancy rating of room to add, reduce or eliminate illumination; and
j. the ability to manually override the occupancy detector function.

1. An electronic switch or intensity controller for a light that is activated by a detectable change of capacitance and/or infrared radiation in the detection field comprising: a CPU connected to a power supply; at least one logic level triac connected electronically to said CPU; and an occupancy sensor connected electronically to said CPU having a means for detecting the presence of objects passing within the detection field.

2. An electronic switch or intensity controller according to claim 1 wherein said means for detecting is by ultrasonic detection, radio frequency detection, or inductance.

3. An electronic switch or intensity controller according to claim 1 further comprising a radio frequency transceiver connected electronically to said CPU so that said switch or controller may be operated remotely.

4. An electronic switch or intensity controller according to claim 1 is configured to operate in a one-way, two-way, three-way and/or four-way capacity.

5. An electronic switch or intensity controller according to claim 1 configured to allow multiple switches to be connected in a daisy-chained configuration to improve detection range.

6. An electronic switch or intensity controller according to claim 1 further comprising a light for illumination.

7. An electronic switch or intensity controller according to claim 6 wherein said light for illumination is of a brightness to illuminate the switch or controller or to additionally allow illumination of an area around said switch or controller.

8. An electronic switch or intensity controller according to claim 1 wherein said change of capacitance is detected without physical contact at a distance of not less than about ⅛ inch and not more than about 3½ inches from said switch or controller.

9. An electronic switch or intensity controller according to claim 1 wherein said change of capacitance is detected upon physical contact with said switch or controller.

10. An electronic switch or intensity controller according to claim 1 wherein said change of capacitance is detected by an audible sound.

11. An electronic switch or intensity controller according to claim 10 wherein said audible sound is a natural or a manmade audibly detectable sound.

12. An electronic switch or intensity controller according to claim 1 wherein said occupancy sensor has the ability to count the number of objects or times an object passes within the detection field in a desired reference time period.

13. An electronic switch or intensity controller according to claim 6 wherein said occupancy sensor has the ability of manual, touch or proximity override of illumination function.
